(19) United States
(12) Patent Application Publication
(10) Pub. No.: US 2026/0205360 A1
(43) Pub. Date: Jul. 16, 2026

(54) DYNAMICALLY INSTALLING AND UNINSTALLING GROUP-BASED POLICIES BASED ON APPLICATION OPERATING ENVIRONMENT ACTIVITY

(71) Applicant: HEWLETT PACKARD ENTERPRISE DEVELOPMENT LP, Spring, TX (US)

(72) Inventor: Rajib Majila, Bangalore (IN)

(21) Appl. No.: 19/172,315

(22) Filed: Apr. 7, 2025

(30) Foreign Application Priority Data
Jan. 10, 2025 (IN) 202541002843

(51) Int. Cl. H04L 41/0894; H04L 45/745; H04L 61/103

(52) U.S. Cl. CPC H04L 41/0894; H04L 45/74591; H04L 61/103

(57) ABSTRACT

A technique includes, on a network device, dynamically installing and uninstalling group-based policies based on application operating environment activity associated with the network device. Installing the group-based policies includes detecting a presence of an application operating environment on a network; responsive to detecting the presence of the application operating environment, determining Internet Protocol (IP) address of the application operating environment; determining a role that is associated with the application operating environment based on the IP address; identifying a given group-based policy corresponding to the role; and installing, by the group-based network device, the given group-based policy on the network device to add the given group-based policy to the composition of group-based policies installed on the network device. The network device regulates network traffic flows received by the network device to enforce the given group-based policy.

### BACKGROUND

Network devices may apply various policies to network traffic flows. For example, a network device may apply a security policy that results in the network device dropping packets of certain prohibited ingress network traffic flows and forwarding packets of other ingress network traffic flows.

### BRIEF DESCRIPTION OF THE DRAWINGS

FIG. 1 is a block diagram of a computer network that includes a network device that determines the roles of application operating environments that are connected to the network device and enforces role-affiliated group-based policies (GBPs), according to an example implementation.

FIG. 2 is a block diagram of a GBP management architecture of a network device according to an example implementation.

FIG. 3 is a flow diagram depicting a technique used by a GBP management architecture to determine the role of an application operating environment connected to a network device, according to an example implementation.

FIG. 4 is a flow diagram depicting a technique used by a GBP management architecture to manage role-IP address associations for a network device according to an example implementation.

FIG. 5 is a flow diagram depicting a technique used by a GBP management architecture to manage GBP installation and removal on a network device according to an example implementation.

FIG. 6 is a flow diagram depicting a technique to dynamically manage the composition of GBPs that are installed on a network device, according to an example implementation.

FIG. 7 is an illustration of a non-transitory storage medium that stores hardware processor-readable instructions that, when executed by a hardware processor of a network device, cause the network device to determine a role associated with an application operating environment, install a GBP corresponding to the role, and selectively uninstall the GBP based on a network activity associated with the application operating environment, according to an example implementation.

FIG. 8 is a block diagram of a system that includes a network device to determine a role associated with an application operating environment based on a gratuitous address resolution protocol (ARP) packet and regulate network traffic flows to enforce a GBP corresponding to the role, according to an example implementation.

### DETAILED DESCRIPTION

A computer network may be segmented, or divided into smaller parts (or “segments”), for such purposes as isolating network traffic flows associated with different users and reducing the broadcast domain. Traditional approaches to segmenting a network involve manually and statically configuring the network to establish layer two (L2) and layer three (L3) boundaries using virtual local area networks (VLANs) and virtual routing and forwarding (VRF). This traditional approach to network segmentation, however, does not scale well for edge networks due to the ever-increasing number of edge devices (e.g., mobile devices and Internet-of-Things (IoT) devices) that have wide ranging access requirements and threat perceptions.

A dynamic and more modern approach to network segmentation uses a distributed and multi-tenanted policy plane. The policy plane implements network segmentation dynamically using policies that are centered on applications. This approach to network segmentation is highly scalable due to the grouping of entities that have similar policy treatments. Moreover, group-based policies (GBPs) may be defined for groups of entities (e.g., a finance group, an accounting group, and so forth), as compared to, for example, policies that are defined for individual entities.

A GBP defines a treatment for certain network traffic flows. In an example, a security-based GBP prohibits certain network traffic flows, such that the packets of these network traffic flows are dropped. In another example, a quality-of-service (QoS)-based GBP specifies preferential treatment (e.g., more bandwidth) for certain network traffic flows. In another example, an IP routing-based GBP specifies Internet Protocol (IP) forwarding addresses for certain network traffic flows.

A GBP defines a treatment for network traffic flows that are associated with a particular source role, a particular destination role, and a particular application. The application has a signature that corresponds to one or multiple network traffic parameters. In examples, the network traffic parameters for a particular application may include one or multiple layer L3-affiliated parameters, such as a source IP address, a destination IP address or a destination IP address sub-net. In other examples, the network traffic parameters may include one or multiple layer four (L4)-affiliated parameters, such as a destination port, a source port or a type of transport protocol (e.g., a User Datagram Protocol (UDP) or a Transport Control Protocol (TCP)). In another example, the network traffic parameters for a particular application may be a combination of one or multiple L3-affiliated parameters and one or multiple L4-affiliated parameters.

Certain network devices (called “GBP enforcers” herein) of the network enforce GBPs. In this context, “enforcing” a GBP refers to recognizing network traffic flows to which the GBP applies and applying a treatment that is prescribed by the GBP. In an example, an access switch, which provides network connectivity for a collection of client devices, may be a GBP enforcer for network traffic flows for which the client devices are traffic destinations.

In one approach to GBP-based network segmentation, the role of a client device is determined as part of a port access authentication process that occurs during the client device's onboarding. The onboarding is initiated, for example, by the connection of the client device to a physical port of an access switch. Pursuant to port access authentication, before the network assigns an IP address to the client device and allows the client device to connect to the network, an authenticator (e.g., a server providing a Remote Authentication Dial-in Service (RADIUS)) validates the client device based on the client device's Media Access Control (MAC) address. If the client device passes authentication, then the network assigns the client device an IP address, the authenticator looks up the client device's role based on the MAC address, and the authenticator provides the client device's role to the access switch.

The above-described approach of using port access authentication to derive client device roles encounters challenges in data center environments. In a data center, application operating environments, such as virtual machines and bare-metal servers, are considered trustworthy, and therefore, the application operating environments do not undergo authentication. Moreover, the application operating environments may not be associated with specific physical network device ports. Therefore, there is no port access authentication or equivalent for the application operating environments. Accordingly, when an application operating environment starts, or launches, in the data center, there is no mechanism in place to trigger determination of the application operating environment's role.

In accordance with example implementations that are described herein, a GBP enforcer (e.g., an Ethernet Virtual Private Network (EVPN) switch) has a GBP management architecture that determines roles for application operating environments that are directly connected to the GBP enforcer. These connected application operating environments are also referred to herein as being “active” application operating environments. The determined roles correspond to destination roles for a collection of GBPs that are installed on and enforced by the GBP enforcer.

More specifically, in accordance with example implementations, a GBP enforcer responds to triggers other than port access authentication to initiate the enforcer's look up of a destination role for an application operating environment that is connected to the GBP enforcer. In an example, a trigger may be a gratuitous address routing protocol (ARP) packet that is sent by the application operating environment when the application operating environment starts, or launches. In another example, a trigger may be an event corresponding to the GBP enforcer's creation of a new MAC address table entry. In another example, a trigger may be an event corresponding to the GBP enforcer's creation of a new ARP table entry.

Instead of determining a destination role based on a MAC address (as occurs with port access authentication), the GBP enforcer determines an application operating environment's destination role by looking up the role from a mapping data structure. The mapping data structure associates IP addresses of application operating environments with their associated roles. More specifically, in accordance with example implementations, an orchestrator (e.g., a cloud-based operator) for the application operating environments provides the mapping data structure.

The GBP enforcer dynamically installs and uninstalls GBPs on the GBP enforcer based the application operating environment activity that is associated with the GBP enforcer. In this context, “dynamically” installing and uninstalling GBPs based on the application operating environment activity refers to the GBP enforcer managing the collection of installed GBPs so that that each installed GBP corresponds to one or multiple connected application operating environments. The application operation environment “activity” refers to application operating environments being connected to the GBP enforcer (e.g., application operating environments starting or launching on servers connected to the GBP enforcer) as well as application operating environments being disconnected from the GBP enforcer (e.g., application operating environments stopping on servers connected to the GBP enforcer or being migrated to other servers). Therefore, in response to detecting the presence of an application operating environment, the GBP enforcer ensures that GBPs corresponding to the application operating environment are installed on the GBP enforcer, and in response to the determining that a particular installed GBP no longer corresponds to any connected application operating environment, the GBP enforcer removes, or uninstalls, the installed GBP.

The dynamic installation and uninstallation of GBPs conserves the limited resources of the GBP enforcer. The GBP enforcer limits the collection of installed GBPS to GBPs that are associated with destination roles (e.g., destination roles associated with application operating environments) that have been identified by the GBP enforcer (i.e., destination roles of entities directly connected to the GBP enforcer). A given ingress network traffic flow may correspond to one of the installed GBPs if, in addition to being associated with the same destination role, the given ingress network traffic flow also corresponds to the source role and network traffic parameters associated with the GBP. In accordance with example implementations, an installed GBP occupies space (e.g., one or multiple entries) of the GBP enforcer's ternary content-addressable memory (TCAM). The TCAM space is a limited resource of the GBP enforcer. Therefore, restricting the installed GBPs to GBPs that correspond to destination roles that have been identified by the GBP enforcer, conserves the GBP enforcer's limited TCAM space.

In accordance with example implementations, the GBP enforcer only keeps GBPs installed, which correspond to destination roles for connected, or active, application operating environments. For example, if a virtual machine (i.e., an application operating environment) is migrated and consequently, due to the migration, is no longer connected to the GBP enforcer, the GBP enforcer is alerted to the virtual machine's inactivity (e.g., alerted due to an ARP table timeout). Upon being notified of a virtual machine's inactivity, the GBP enforcer determines whether there is any other connected application operating environment that has the role of the now inactive virtual machine. If the role is not affiliated with any other active application operating environment, then the GBP enforcer removes, or uninstalls, the corresponding GBP. In an example, the removal of an installed GBP includes the GBP enforcer deleting, from its TCAM, one or multiple entries corresponding to the GBP. Therefore, restricting the collection of installed GBPs to GBPs that correspond to active application operating environments is another way that the GBP enforcer conserves its limited TCAM space.

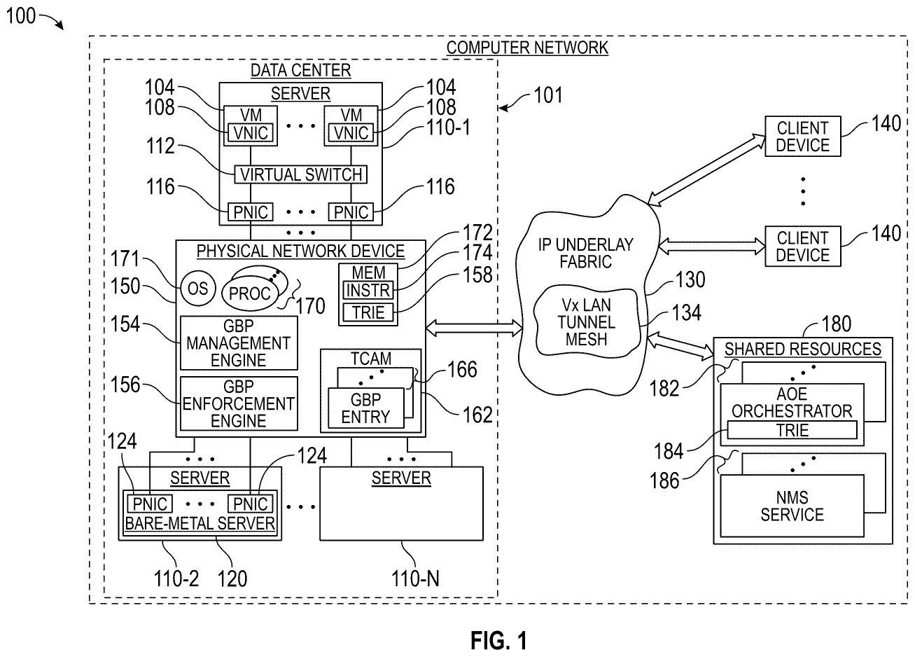

Referring to FIG. 1, as a more specific example, a computer network 100 includes one or multiple data centers 101. In accordance with example implementations, the data center(s) 101 may be associated with a cloud. In the context that is used herein, a “cloud” refers to a computer system that is associated with resources that can be scaled up and down on demand. In a more specific example, a data center 101 corresponds to a business entity's private cloud that is managed by the business entity. In an example, the data center 101 is a co-location data center. In another example, the data center 101 is located on-premise on the business entity's private property.

In another example, the data center 101 corresponds to a hybrid cloud that is managed by a public cloud operator, and the data center 101 is located on-premise or corresponds to a co-location datacenter. In another example, the data center 101 corresponds to a public cloud that is owned and managed by a public cloud operator, and the public cloud provides cloud services to the general public.

The data center 101 includes rows of racks, and multiple servers may be mounted in each rack. FIG. 1 depicts N exemplary servers 110 with servers 110-1, 110-2 and 110-N being specifically shown. The servers 110 are connected to an actual, or physical, network device 150. The network device 150 connects the servers 110 to a physical network fabric, or IP underlay fabric 130. In an example, the network device 150 is an EVPN switch. In accordance with example implementations, the IP underlay fabric 130 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

In accordance with some implementations, the servers 110 may be enclosure-based servers (e.g., blade servers), rack servers (e.g., density line (DL) servers), tower servers or a combination of the foregoing servers. In an example, the servers 110-1 to 110-N are located in the same rack, and the network device 150 is a top-of-the-rack (ToR) switch (e.g., an EVPN ToR switch).

A given server 110 has a host that has an unabstracted view of the actual, or physical, resources (e.g., physical central processing unit (CPU) cores, physical memory and physical storage) of the server 110. In an example, a host may include a host operating system and one or multiple type two hypervisors that have unabstracted views of the server's physical resources. The host operating system and the type two hypervisor(s) have unabstracted views of the server's physical resources. In another example, a host includes one or multiple type one hypervisors that run on bare-metal and have unabstracted views of the server's physical resources.

The host supports (or “hosts”) one or multiple application operating environments. In the context that is used herein, an “application operating environment” generally refers to a machine abstraction in which one or multiple application processes execute.

A virtual machine is an example of an application operating environment. In a more specific example, as depicted in FIG. 1 for the server 110-1, virtual machines 104 may be considered respective application operating environments. In this context, a “virtual machine” (also called a “guest virtual machine,” a “virtual machine instance,” or “a guest virtual machine instance”) refers to a virtual environment that functions as a machine level abstraction, or virtual computer system, which has its own virtual resources (e.g., virtual CPU cores, virtual Graphics Processing Unit (GPU) cores, a virtual system memory allocation, one or multiple network interfaces, and one or multiple virtual storage devices) that correspond to underlying physical resources (e.g., physical resources of the server 110-1). Moreover, a virtual machine has its own abstraction of an operating system, which is referred to as a “guest” operating system.” For example, a virtual machine 104 has a guest operating system that is an abstraction of a host operating system of the server 110-1. The lifecycle (e.g., the deployment and termination) of a virtual machine 104 may be managed by a hypervisor of the server 110-1.

A bare-metal server is another example of an application operating environment. In an example, as depicted in FIG. 1 for the server 110-2, the server 110-2 hosts a bare-metal server 120. The software of the bare-metal server 120 has full access to physical resources of the server 110-2, such as the server's CPU cores, GPU cores, physical memory, as well as other resources of the server 110-2, which are exposed to the software. Resources of the server 110-2 may be hidden from the software (and therefore, from the tenant of the bare-metal server 120) for a number of different reasons, such as, for example, the tenant not wanting to pay for certain resources, controlling the quality of service (as exposing the resources may affect performance of the bare-metal server 120), and so forth. Any of a number of resource restrictions may be placed on the bare-metal server 120, such as restrictions on specific hardware devices (e.g., GPU cores, CPU cores, Non-Volatile Memory express (NVMe) drives, as well as other hardware components); a restriction of memory above a certain capacity; a restriction of CPU core frequency above a certain frequency limit; and/or other resource restrictions.

Application operating environments of the data center 101, such as the virtual machines 104 and the bare-metal server 120, are connected to the network switch 150. In an example, each virtual machine 104 of the server 110-1 includes a virtual network interface controller (VNIC) 108, and the VNICs 108 are connected to virtual ports of a virtual switch 112 that is hosted on the server 110-1. Other virtual ports of the virtual switch 112 are connected to respective physical NICs (or “PNICs”) 116 of the server 110-1. The PNICs 116 are connected to respective physical ports of the network device 150. Each virtual machine 104 has an associated IP address. In another example, the bare-metal server 120 of the server 110-1 includes PNICs 124 that are connected to respective physical ports of the network device 150. The bare-metal server 120 has an associated IP address.

A client device 140, which is located in the network edge and connected to the IP underlay fabric 130, may generate a network traffic flow that targets an application process that executes in an application operating environment of the data center 101. For this purpose, the IP address of the client device 140 is the source IP address associated with the network traffic flow, and the IP address of the targeted application environment is the destination IP address of the network traffic flow. In a similar manner, an application process executing in an application operating environment of the data center 101 may target a particular client device 140. For this purpose, the IP address of the application operating environment is the source IP address of the network traffic flow, and the IP address of the client device 140 is the destination IP address of the network traffic flow.

As described further herein, the network device 150 serves as a GBP enforcer for network traffic flows that are sent to application operating environments (e.g., the virtual machines 104 and the bare-metal server 120) that are directly connected to the network device 150. In accordance with example implementations, a collection of GBPs are programmed in, or installed on, the network device 150. For this purpose, in an example, the network device 150 includes a TCAM 162, and the installed GBPs correspond to entries 166 (called “GBP entries 166” herein) of the TCAM 162. The TCAM 166 is used by a GBP enforcement engine 156 of the network device 150 to quickly and efficiently recognize applicable installed GBPs for a given ingress network traffic flow. Moreover, the TCAM 166 provides information that aids the GBP enforcement engine 166 in applying the GBPs.

In accordance with example implementations, a GBP entry 166 contains data representing a mask, a value and a result. In examples, a mask identifies an IP address or an IP address sub-net. In an example, the value includes a collection of network traffic parameters (e.g., one or multiple L3 parameters and/or one or multiple L4 parameters). In an example, the value identifies source and destination roles corresponding to the GBP policy. Collectively, the mask and the value identify a particular application, a source role and a destination role for a particular GBP policy. A particular GBP policy may correspond to one or multiple GBP entries 166. The result of a GBP entry 166 represents a decision that is selected when there is a match (or “hit”) with the combination of the mask and value. In an example, for a security-based GBP, a result may be either “permit” or “deny,” thereby indicating to the GBP enforcement engine 156 whether to pass the packets of the ingress network traffic flow to the application operating environment or drop the packets. In another example, for a QoS-based GBP, a result may be a pointer to a QoS policer of the GBP enforcement engine 156. The QoS policer applies a certain QoS policy (e.g., an increased bandwidth) to the ingress network traffic flow. In another example, for an IP routing-based GBP, a result may be an IP forwarding address.

The network switch 150 further includes a GBP management engine 154. As further described herein, the GBP management engine 154 determines destination roles for application operating environments that are directly connected to the network switch 150. Moreover, as further described herein, the GBP management engine 154 manages the collection of GBPs that are installed on the network switch 150 in a way that conserves the limited resources (e.g., TCAM space) of the network switch 150.

For purposes of segmenting the computer network 100, a network administrator may configure the computer network 100 with GBPs to control the treatment of network traffic for different groups. In an example, a security-based GBP defines permissible traffic patterns across security groups or within a certain security group. In another example, a QoS-based GBP defines relative higher bandwidths for network traffic flows within certain groups or between certain groups. In another example, a routing-based GBP defines forwarding IP addresses for network traffic flows within certain groups or across certain groups.

A GBP is associated with one or multiple source roles and one or multiple destination roles. GBPs can help in both micro-segmenting and macro-segmenting network traffic based on application attributes. In this context, “macro-segmenting” network traffic refers to controlling the network traffic by dividing the computer network 100 into different zones and controlling access of user devices to the different zones based on roles (e.g., finance and accounting) associated with the devices. “Micro-segmenting” network traffic refers to controlling the network traffic at a finer granular level by controlling the treatment of network traffic based on the roles and applications associated with the network traffic.

The following is an example of GBP-based segmentation. In this example, a packet originates with a sender network endpoint device (called the “sender”) and targets a destination network endpoint device (called the “destination”). For example, the sender may be a client device 140. The sender is connected to an ingress node (e.g., an EVPN edge switch) of the IP underlay fabric 130. The ingress node profiles the sender, and this profiling includes the ingress node determining the role of the sender. The role of the sender is referred to herein as the “source role.” The ingress node encapsulates the profile information in accordance with an overlay encapsulation protocol (e.g., a Virtual eXtensible Local Area Network (VxLAN) protocol). In an example, the encapsulated profile information corresponds to an identifier, which is referred to herein as a “GBP tag.”

Continuing the GBP-based segmentation example, a port authentication process used as part of the prior onboarding of the sender onto the computer network 100, associates the MAC address of the sender with a role (the “destination role” for the GBP-based segmentation example). For example, as part of the prior onboarding of the sender onto the computer network 100, a RADIUS authentication service authenticates the sender based on the sender's MAC address. Responsive to the successful authentication of the sender, the RADIUS service looks up the role, and the RADIUS service sends the role to the ingress node. The ingress node includes the role (here the “destination role”), into the GBP tag. As can be appreciated, the GBP tag plays an important role in the GBP enforcement.

The ingress node for the GBP-based segmentation example serves as a tunnel endpoint to send the packet across an overlay tunnel to an egress tunnel endpoint (e.g., an EVPN device) that may serve as the egress node that is connected to the destination. For the example implementation that is depicted in FIG. 1, a VxLAN tunnel mesh 134 overlays the IP underlay fabric 130 and corresponds to multiple VxLAN tunnels.

The egress node serves as the GBP enforcer. The egress node examines the source and destination roles associated with the packet as well as examines network traffic attributes of the packet. The egress node performs this examination for purposes of determining whether any of the GBPs installed on the egress node are to be applied to the packet. If the destination corresponds to a network device that underwent port access authentication (as part of the network device's onboarding), then the egress node is aware of the destination role. The egress node derives the source role from the GBP tag.

For the example implementation that is depicted in FIG. 1, the network device 150 serves as a GBP enforcer for packets that are sent to entities that are directly connected to the network device 150, including various application operating environments, such as the exemplary virtual machines 104 and the exemplary bare-metal server 120. A challenge with the network device 150 serving as a GBP enforcer is that because the application operating environments of the data center 101 are considered to be trustworthy, the application operating environments do not undergo port access authentication. Accordingly, without the features described herein, the network device 150 would be unaware of the roles for the application operating environments. Therefore, without these features, when an application operating environment connected to the network device 150 starts, or launches, there would be no mechanism in place to trigger the network switch 150 to determine the role of the application operating environment.

In accordance with example implementations that are described herein, the GBP management engine 154 of the network device 150 determines the roles of the application operating environments that are connected to the network device 150. Moreover, the GBP management engine 154 manages the collection of GBPs that are installed on the network device 150 in a way that conserves the limited resources (e.g., TCAM space) of the network device 150.

More specifically, in accordance with example implementations, the GBP management engine 154 is constructed to respond to certain triggers that occur when an application operating environment that is connected to the network switch 150 starts, or launches; and any of these triggers initiate the engine's look up of a role for the application operating environment. In an example, the trigger may be a gratuitous ARP packet that is sent by an application operating environment's operating system when the application operating environment starts. According to the ARP, a requesting network device broadcasts a packet (called an “ARP request packet”) to learn a MAC address corresponding to a particular IP address (contained in the ARP request packet). A responding network device having the IP address responds to the ARP request with a response (called the “ARP response packet”) that contains the responding network device's MAC address.

A “gratuitous ARP packet” refers to an ARP response packet that does not have a corresponding ARP request packet (i.e., the gratuitous ARP packet is sent by a network device without being requested or solicited to do so). In an example, the operating system (e.g., a guest operating system of a virtual machine 104 or a host operating system of a bare-metal server 120) may be configured to send out a certain number (e.g., three) of gratuitous ARP packets when the corresponding application operating environment starts. A network device, such as the network device 150, may potentially miss (e.g., drop) certain particular packets, such as one or multiple gratuitous ARP packets. Therefore, in accordance with example implementations, other events may also serve as triggers to initiate the GBP management engine's look up of an application operating environment's role.

In another example, an event that is performed by the network device 150 when the network device 150 detects an application operating environment serves as a trigger to initiate the GBP management engine's look up of the application operating environment's role. For example, the network device 150 adds an entry to its MAC table in response to the network device 150 detecting a new MAC address, such as the MAC address associated with a newly detected application operating environment. The new MAC table entry event serves as a trigger to initiate the GBP management engine's look up of the application operating environment's role. In another example, the network device 150 adds an entry to its ARP table in response to the network device 150 associating an IP address with a particular MAC address. The creation of an ARP table entry due to a newly connected application operating environment serves as a trigger to initiate the GBP management engine's look up of a role for the application operating environment.

In accordance with example implementations, instead of determining the role of an application operating environment based on the environment's MAC address (as occurs with port access authentication), the GBP management engine 154 determines the role using the application operating environment's IP address as a look up key. More specifically, in accordance with example implementations, an application operating environment orchestrator 182 (e.g., a cloud-based operator) for application operating environments that are hosted by the servers 110 of the data center 101 provides a data structure 184 (called the “TRIE structure 184” herein) that represents a “TRIE.” A “TRIE” may also be referred to as a “retrieval tree” or a “prefix tree.”

The TRIE structure 184 is associated with a particular application operating environment operator 182 and contains data that maps IP addresses of application operating environments to roles. The TRIE structure 184 is organized as a tree of nodes. Each node of the tree, other than the tree's root node, corresponds to a particular IP address prefix. Each node has an associated value that corresponds to a role that is assigned to the IP address prefix.

In accordance with example implementations, network devices of the computer network 100, such as the network device 150, are managed as part of a network management service (NMS) cluster. In accordance with example implementations, a central server of the NMS cluster includes an NMS service 186 (among other NMS services 186) that pushes TRIE structures, such as the TRIE structure 184, to the managed network devices of the NMS cluster. In an example, the NMS service 186 pushes new TRIE structures to the managed network devices responsive to changes in application environment IP address associations and/or role associations. In examples, a change may be attributable to the launching of a new application operating environment, a virtual machine migration or other reason. As depicted in FIG. 1, in accordance with example implementations, the network device 150 stores data in a memory 172 of the network device 150, which represents a local copy 158 of the TRIE (called the “TRIE structure 158” herein).

The GBP management engine 154 uses the TRIE structure 158 as follows for purposes of looking up the role of an application operating environment. The GBP management engine 154 uses the IP address of the application operating environment as a search key for the TRIE structure 158. More specifically, the GBP management engine 154 performs a longest prefix match (LPM) in which the GBP management engine 154 finds the node of the TRIE structure 158 that matches the longest prefix of the IP address (the search key). This node has a value that corresponds to the role that is assigned to the application operating environment. In an example, the value corresponds to the IP address of the application operating environment. In another example, the value corresponds to an IP address sub-net that encompasses the IP address of the application operating environment.

The GBP management engine 154 manages the collection of GBPs that are installed on the network device 150 in a number of different ways for purposes of conserving the resources of the network device 150. In an example, the GBP management engine 154 limits the on-device GBP installation to GBPs that are associated with destination roles of devices and application operating environments that are directly connected to the ports of the network device 150. A given ingress network traffic flow may correspond to one of the installed GBPs, depending on the source role associated with the network traffic flow, as well as the traffic flow parameters. In an example, the installation of a GBP includes the GBP management engine 154 adding one or multiple GBP entries 166 corresponding to the installed GBP.

In another example of the conservation of the network device's resources, the GBP management engine 154 only keeps GBPs installed, which correspond to destination roles for active application operating environments. For example, if a virtual machine 104 is migrated and is no longer connected to the network device 150, the GBP management engine 154 is alerted to the virtual machine inactivity (e.g., alerted due to an ARP table timeout). In response to such an alert, the GBP management engine 154 determines whether there is any other application operating environment that has the role of the now inactive virtual machine 104. If the role is not affiliated with any other active application operating environment, then the GBP management engine 154 removes, or uninstalls, the corresponding GBP. In an example, the removal of an installed GBP includes the GBP management engine 154 deleting, from the TCAM 162, one or multiple GBP entries 166 corresponding to the removed GBP.

In accordance with example implementations, the network device 150 is a computer platform. In the context that is used herein, a “computer platform” refers to a processor-based electronic device, which has an associated operating system, such as exemplary operating system 171. The network device 150 includes one or multiple hardware processors 170. In an example, a hardware processor 170 may include one or multiple CPU cores. In another example, a hardware processor 170 may include one or multiple CPU packages, or sockets. The hardware processor(s) 170, in general, executes hardware processor-readable instructions 174 that are stored in the network device's memory 172.

The memory 172, as well as other memories that are discussed herein are non-transitory storage media that may be formed from semiconductor storage devices, memristor-based storage devices, magnetic storage devices, phase change memory devices, a combination of devices of one or more of these storage technologies, and so forth. The non-transitory storage media may represent a collection of volatile memory devices and non-volatile memory devices, in accordance with example implementations.

As used herein, an “engine,” such as the GBP management engine 154 and/or the GBP enforcement engine 156, can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An “engine” can refer to a combination of one or more hardware processing circuits and machine-readable instructions (software and/or firmware) executable on the one or more hardware processing circuits. In an example, the GBP management engine 154 and/or the GBP enforcement engine 156 may be formed by one or multiple hardware processors 170 of the network device 150 executing instructions 174 that are stored in the memory 172. In an example, in accordance with some implementations, the instructions 174 that are executed to form the GBP management engine 154 and/or the GBP enforcement engine 156 may be firmware instructions. In another example, the GBP management engine 154 and/or the GBP enforcement engine 156 may be formed in whole or in part by a PLD, ASIC, FPGA or other hardware of the network device 150.

Application operating environment orchestrators 182 and NMS services 186 may be hosted on shared resources 180. In examples, the shared resources 180 may be associated with a public cloud. In an example, the NMS services 186 may be associated with a central server that, in turn, is affiliated with an NMS cluster that includes managed network devices, including the network device 150. In addition to an NMS service 186 that pushes TRIE structures 184 to the managed network devices, other NMS services 186 may provide a variety of functions. In an example, NMS services 186 may be used to configure managed network devices; schedule and initiate firmware upgrades; visualize, analyze, log, collect, query and/or monitor network telemetry metrics; identify potential or actual network device failure issues; as well as be used for other network device-related tasks.

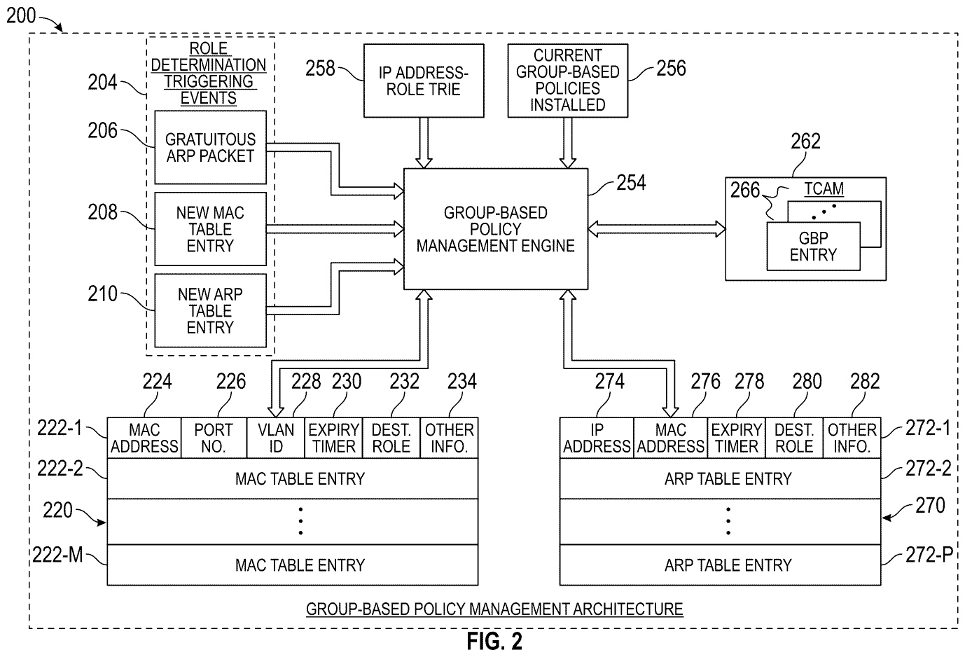

FIG. 2 depicts a GBP management architecture 200 in accordance with example implementations. Referring to FIG. 2, the GBP management architecture 200 includes a GBP management engine 254 and a TCAM 262. The GBP management engine 154 and the TCAM 162 of FIG. 1 are examples of the GBP management engine 254 and the TCAM 262, respectively. A GBP enforcer, such as the network device 150 of FIG. 1, in accordance with example implementations, may implement the GBP management architecture 200.

In accordance with example implementations, the GBP management engine 254 initiates a process to determine a role for a particular application operating environment responsive to a role determination triggering event 204. As depicted in FIG. 2, a role determination triggering event 204 may correspond to a received gratuitous ARP packet 206, creation of a new MAC table entry 208 or creation of a new ARP table entry 210.

For purposes of determining the role of a particular application operating environment, the GBP management engine 254 accesses an IP address-role TRIE structure 258. The IP address-role TRIE structure 258 is a mapping data structure that is provided by an application operating environment orchestrator (e.g., the application operating environment orchestrator 182 of FIG. 1). The TRIE structure 258 includes data representing IP address-to-role mappings for application operating environments.

The GBP management engine 254, in accordance with example implementations, limits the collection of GBPs that are installed on the network device to the roles of devices and application operating environments that are directly connected to the ports of the network device. A given GBP may be represented by one or multiple GBP entries 266 of the TCAM 262. The GBP management engine 254 also monitors for application operating environment inactivity, such as inactivity that occurs due to, for example, migration of a particular virtual machine. For this purpose, the GBP management engine 254 manages a MAC table 220 and an ARP table 270.

For the example implementation depicted in FIG. 2, the MAC table 220 has M entries 222 (called “MAC table entries” herein). In particular, FIG. 2 depicts exemplary MAC table entries 222-1, 222-2 and 222-M. Each MAC table entry 222 is associated with a particular MAC address. FIG. 2 depicts specific exemplary fields for the MAC table entry 222-1. The MAC table entry 222-1 includes a field 224 that contains data representing the corresponding MAC address. The MAC table entry 222-1 also includes a field 226 containing data that represents a port number and a field 228 containing data representing a VLAN identifier (ID). In accordance with example implementations, each MAC table entry 222 further includes a field, such as exemplary field 232 of the MAC table entry 222-1, that represents a destination role associated with the MAC address. For a corresponding application operating environment, the destination role is determined by the GBP management engine 254.

Each MAC table entry 222 may further include a field, such as exemplary field 230 for the MAC table entry 222-1, which includes data representing an expiry timer for the MAC table entry 222. The expiry timer expires to indicate inactivity of the MAC table entry 222. In an example, the expiry timer 230 is a count down timer that is initialized whenever the associated MAC table entry 222 is updated, and otherwise, the expiry timer counts down. The MAC table entry 222 may contain one or multiple other fields 234 containing data representing other information (e.g., a designation of whether the MAC table entry is dynamic and automatically learned or static) associated with the MAC address.

In accordance with example implementations, the ARP table 270 has P ARP table entries 272, and each ARP table entry 272 is associated with a particular IP address. FIG. 2 depicts specific fields for the ARP table entry 272-1, with other entries 272 containing similar fields. The entry 272-1 includes a field 274 representing the associated IP address, as well as a field 276 containing data representing a MAC address. Moreover, in accordance with example implementations, similar to the MAC table entry 222, the ARP table entry 272-1 includes a field 278 representing an expiry timer and a field 280 containing data representing a destination role. The expiry timer for an ARP table entry 272, similar to the expiry timer for the MAC table entry 222, expires to indicate inactivity of the ARP table entry 272. The ARP table entry 272-1, as depicted in FIG. 2, may contain one or multiple other fields 272 containing data representing other information, such as, for example, data identifying a specific interface upon which the MAC address was discovered, the IP address of another device connected to the same network, and so forth.

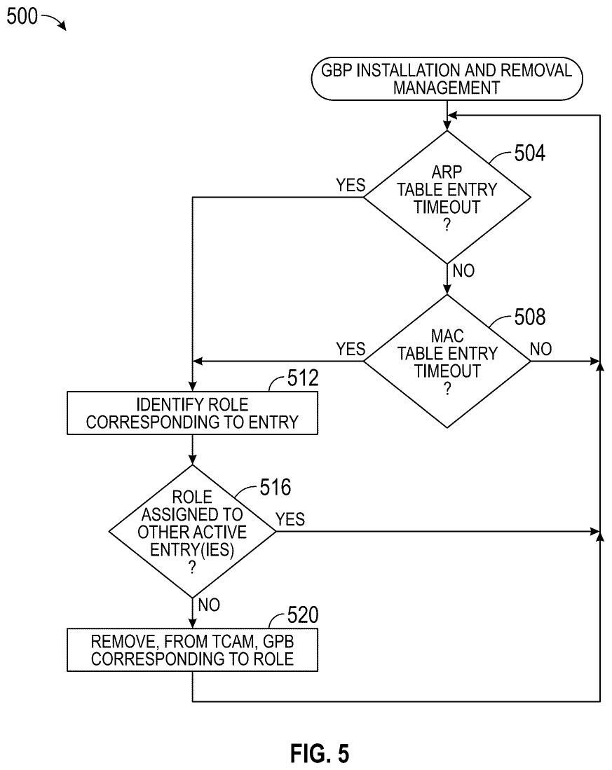

The GBP management engine 254, in accordance with example implementations, is alerted to the expiration of a MAC table entry 222 for purposes of being notified of a possible inactive application operating environment. In a similar manner, the GBP management engine 254 monitors for expired ARP table entries 272 for purposes of identifying potential inactive application operating environments. As discussed further below in connection with FIG. 5, the GBP management engine 254 may remove a particular application operating environment in response to detecting its inactivity. In accordance with some implementations, the GBP management engine 254 maintains data 256 representing the current GBP policies that are installed on the network device.

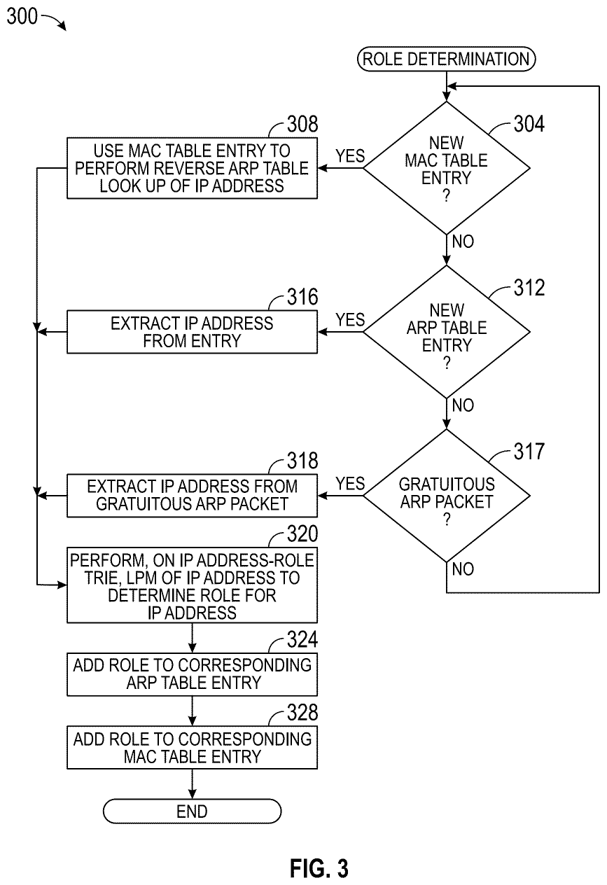

FIG. 3 is a flow diagram depicting a technique 300 used by a GBP management architecture for purposes of determining the role of an application operating environment. In an example, the technique 300 may be performed by a GBP management engine, such as the GBP management engine 154 of FIG. 1 or the GBP management engine 254 of FIG. 2. The GBP management engine is part of a network device (e.g., the network device 150 of FIG. 1).

The GBP management engine, in general, monitors for events that serve as triggers to initiate determination of a role for an application operating environment. The triggers correspond to decision blocks 304, 312 and 317. More specifically, the technique 300 includes the GBP management engine determining (decision block 304) whether a new MAC table entry has been created. In this manner, the network device creates a new MAC table entry responsive to detecting the connection of the device associated with the MAC address to the network device. Pursuant to block 308, the GBP management engine uses the MAC table entry to perform a reverse ARP table look up of the corresponding IP address. In this context, a “reverse ARP table look up” refers to the GBP management engine determining an IP address for the corresponding MAC address. In an example, the GBP management engine may initiate the sending of an ARP request for purposes of receiving an ARP response packet containing data associating the MAC address with the MAC address. In another example, the GBP management table searches the network device's ARP table for purposes of finding a corresponding ARP table entry containing the IP address.

Pursuant to the technique 300, the GBP management engine determines (decision block 312) whether a new ARP table entry has been created. If so, then, pursuant to block 316, the GBP management engine extracts the IP address from the ARP table entry.

Pursuant to decision block 317 of the technique 300, the GBP management engine determines whether a gratuitous ARP packet has been received. If so, then the GBP management engine extracts (block 318) the IP address from the gratuitous ARP packet.

Therefore, if the GBP management engine detects one of the events corresponding to decision block 304, decision block 312 or decision block 317, then the GBP management engine derives an IP address for the corresponding application operating environment. More specifically, pursuant to block 320, the GBP management engine performs, on an IP address-role TRIE structure, a longest prefix match of the IP address to determine the role for the IP address. Pursuant to block 324, the GBP management engine adds the determined role to an ARP table entry that corresponds to the IP address. Moreover, pursuant to block 328, the GBP management engine adds the determined role to the MAC table entry corresponding to the IP address.

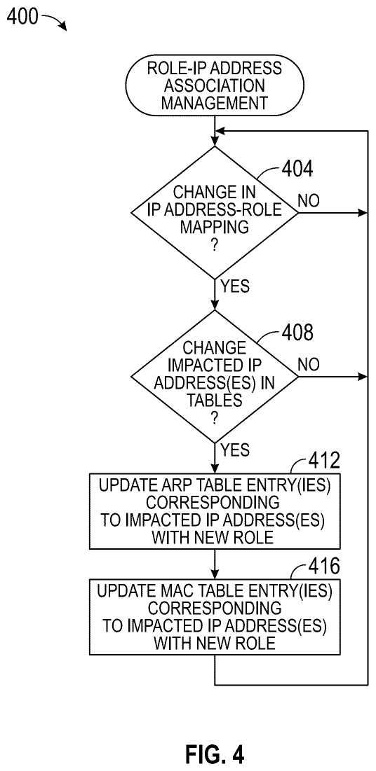

FIG. 4 depicts a technique 400 that may be performed by a GBP management architecture for purposes of tracking IP address-role mappings. In an example, the technique 400 may be performed by a GBP management engine, such as the GBP management engine 154 of FIG. 1 or the GBP management engine 254 of FIG. 2. The GBP management engine is part of a network device (e.g., the network device 150 of FIG. 1).

Referring to FIG. 4, pursuant to the technique 400, the GBP management engine determines (decision block 404) whether there is a change in an IP address-role mapping. A change in an IP address-role mapping may be due to any of a number of different reasons. In an example, an application operating environment orchestrator (e.g., an application operating environment orchestrator 182 of FIG. 1) may assign a new role to a group of one or multiple application operating environments. Determining whether there is a change in the IP address-role mapping may be performed in a number of different ways. In an example, the application operating environment orchestrator may notify the managed network devices when IP address-role mapping has changed. In another example, the GBP management engine compares a newly-received TRIE structure to the previous version of the TRIE structure to determine if changes have occurred. It is noted that the TRIE structure may change without affecting, or impacting, any application operating environment connected to the network device.

Pursuant to decision block 408, the GBP management engine determines if the change impacts one or multiple IP addresses in its tables (e.g., the MAC table and/or the ARP table). In an example, a mapping in the TRIE structure may have changed, but the corresponding IP address may not be an IP address of an application operating environment that is directly connected to the network device. In another example, the change may be associated with an IP address of an application operating environment that is directly connected to the network device. For example, an application operating environment may correspond to an IP sub-net, and the orchestrator may have changed the role corresponding to the IP sub-net. This change may affect multiple application operating environments. In another example, an orchestrator may have changed the role corresponding to a specific IP address, and an application operating environment corresponding to this specific IP address may be directly connected to the network device.

If, pursuant to decision block 408, the change impacts an IP address of an application operating environment that is connected to the network device, then, the GBP management engine updates the network device. More specifically, pursuant to block 412, the GBP management engine updates any ARP table entries corresponding to the impacted IP address(es) with the new role. Moreover, pursuant to block 416, the GBP management engine updates the MAC table entry(ies) corresponding to the impacted IP address(es) with the new role. As can be appreciated, a single role change for a particular IP sub-net may involve multiple ARP table entry changes and multiple MAC table entry changes.

FIG. 5 depicts a technique 500 that may be used by a GBP management architecture for purposes of ensuring that each GBP of the collection of GBPs installed on a network device is associated with an active application operating environment (i.e., an application operating environment that is connected to a network device having the GBP management architecture). In this manner, a GBP management engine (e.g., the GBP management engine 154 of FIG. 1 or the GBP management engine 254 of FIG. 2) may regularly perform the technique 500 for purposes of ensuring that GBPs are not installed for corresponding inactive application operating environments. In an example, a GBP was previously installed on the network device due to the GBP being associated with one or multiple connected application operating environments. However, all the application operating environment(s) may have since been migrated or shut down such that the GBP is no longer associated with any active, or connected, application operating environment.

In accordance with some implementations, the GBP management engine periodically calls the technique 500 for purposes of determining whether there are any ARP or MAC table entry timeouts. In another variation, in accordance with some implementations, the network device generates an interrupt whenever an expiry timer of either the ARP table or the MAC table expires, and the technique 500 corresponds to an interrupt service routine.

Pursuant to the technique 500, the GBP management engine determines (decision block 504) whether there is an ARP table entry timeout and determines (decision block 508) whether there is a MAC table entry timeout. A timeout of either entry indicates that the corresponding application operating environment has become inactive. When this occurs, the GBP management engine determines whether the corresponding GBP is being used, and if not, removes the GBP.

More specifically, pursuant to block 512, the GBP management engine identifies a role corresponding to the ARP table entry or MAC table entry. The GBP management engine next determines, pursuant to decision block 516, whether the role is assigned to any other active ARP table entries or MAC table entries. Stated differently, the GBP management engine determines whether the corresponding GBP is being used by (or is associated with) an active application operating environment. If so, then the GBP management engine leaves the corresponding GBP installed on the network device. Otherwise, pursuant to block 520, the GBP management engine removes, from the TCAM, the GBP corresponding to the role. The removal of the GBP may include removing one or multiple entries from the TCAM.

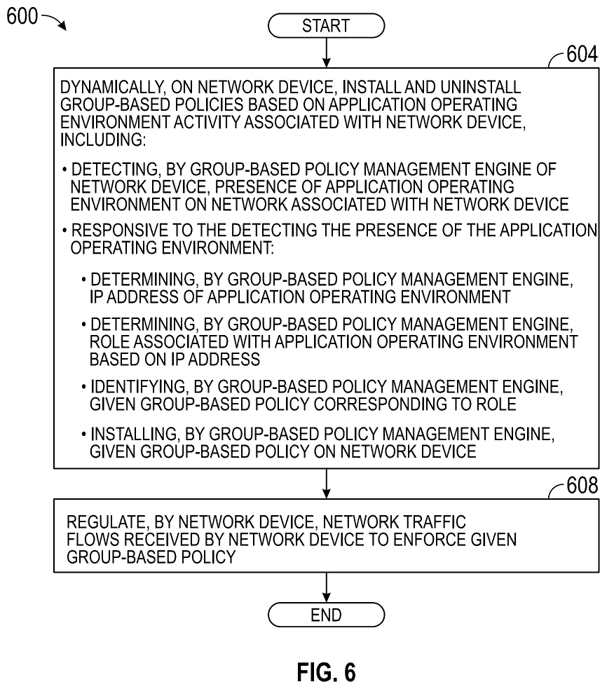

Referring to FIG. 6, in accordance with example implementations, a technique 600 includes, pursuant to block 604, dynamically, on a network device, installing and uninstalling group-based policies based on application operating environment activity associated with the network device. In an example, the application operating environment is a virtual machine. In another example, the application operating environment is a bare-metal server. In an example, the network device is a switch. In an example, the network device is an EVPN switch. In an example, the network device is a ToR switch.

Dynamically installing and uninstalling the group-based policies includes detecting (block 604), by a group-based policy management engine of the network device, presence of an application operating environment on the network. In an example, detecting the presence of the application operating environment includes receiving a gratuitous ARP packet. In an example, detecting the presence of the application operating environment includes detecting the creation of a new MAC table entry. In an example, detecting the presence of the application operating environment includes detecting the creation of a new ARP table entry.

Dynamically installing and uninstalling the group-based policies further includes, pursuant to block 604, responsive to the detection of the presence of the application operating environment, determining, by the network device, an IP address of the application operating environment. In an example, determining the IP address includes extracting the IP address from a gratuitous ARP packet. In an example, determining the IP address includes performing a reverse ARP look up. In an example, determining the IP address includes extracting the IP address from a new ARP table entry.

Dynamically installing and uninstalling the group-based policies further includes, pursuant to block 604, responsive to the detection of the presence of the application operating environment, determining, by the network device, a role that is associated with the application operating environment based on the IP address. In an example, determining the role accessing a mapping data structure. In an example, determining the role includes accessing a TRIE data structure containing data mapping IP addresses to roles. In an example, determining the role includes performing a longest prefix match on a TRIE structure associated with an IP address-to-role mapping. In an example, determining the role includes determining the role associated with the exact IP address associated with the application operating environment. In an example, determining the role includes determining a role associated with a sub-net associated with the IP address. In an example, determining the role includes accessing a mapping structure provided by an orchestrator that caused the starting, or launching, of the application operating environment.

Pursuant to block 604, responsive to detecting the presence of the application operating environment, the technique 600 includes identifying, by the network device, a given group-based policy that corresponds to the role, and installing, by the group-based management engine, the given group-based policy on the network device. In an example, the group-based policy is associated with a source role and a destination role. In an example, the role determined by the network device is the destination role. In an example, the network device determines the source role from a tag of a network packet. In an example, the group-based policy is associated with one or multiple L3 traffic parameters. In an example, the group-based policy is associated with one or multiple L4 parameters.

The technique 600 includes regulating (block 608), by the network device, network traffic flows that are received by the network device to enforce the group-based policy. In an example, regulating the network traffic flows includes applying a QoS policy treatment. In an example, regulating the network traffic flows includes applying a security policy treatment. In an example, regulating the network traffic flows includes applying a routing policy treatment.

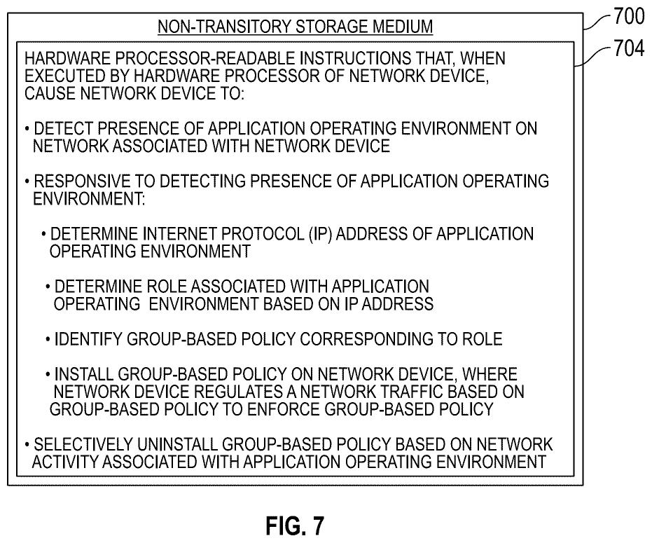

Referring to FIG. 7, in accordance with example implementations, a non-transitory storage medium 700 stores hardware processor-readable instructions 704. The instructions 704, when executed by a hardware processor of a network device, cause the network device to detect presence of an application operating environment on a network that is associated with the network device. In an example, the storage medium 700 corresponds to a collection of memory devices of the network device. In an example, the network device is a switch. In an example, the network device is an EVPN switch. In an example, the network device is a ToR switch. In an example, the hardware processor includes one or multiple CPU cores. In an example, the application operating environment is a virtual machine. In an example, the application operating environment is a bare-metal server. In an example, the instructions 704 correspond to a GBP management engine of the network device.

In an example, detecting the presence of the application operating environment includes detecting a gratuitous ARP packet sent by the application operating environment. In an example, detecting the presence of the application operating environment includes detecting the creation of a new MAC table entry on the network device. In an example, detecting the presence of the application operating environment includes detecting the creation of a new ARP table entry on the network device.

The instructions 704, when executed by the hardware processor, further cause the network device to, responsive to detecting the presence of the application operating environment, determine an IP address of the application operating environment. In an example, determining the IP address includes extracting the IP address from a gratuitous ARP packet. In an example, determining the IP address includes performing a reverse ARP look up. In an example, determining the IP address includes extracting the IP address from an ARP table entry.

The instructions 704, when executed by the hardware processor, further cause the network device to, responsive to detecting the presence of the application operating environment, determine a role that is associated with the application operating environment based on the IP address. In an example, the role is a destination role. In an example, determining the role includes accessing a mapping data structure, which contains data mapping IP addresses to roles. In an example, the mapping data structure is a TRIE structure. In an example, the mapping data structure is provided by an orchestrator of the application operating environment. In an example, determining the role includes performing a longest prefix match on a TRIE structure containing a role-to-IP address mapping. In an example, determining the role includes using the IP address as a search key when applied to the TRIE structure.

The instructions 704, when executed by the hardware processor, further cause the network device to identify a group-based policy corresponding to the role. In an example, the group-based policy is associated with the role determined by the network device. In an example, the group-based policy is associated with a destination role and a source role. In an example, the group-based policy is associated with one or multiple L3 traffic parameters. In an example, the group-based policy is associated with one or multiple L4 parameters. In an example, the group-based policy is a security policy. In an example, the group-based policy is a QoS policy. In an example, the group-based policy is a routing policy.

The instructions 704, when executed by the hardware processor, further cause the network device to, responsive to detecting the presence of the application operating environment, install the group-based policy on the network device. The network device regulates a network traffic based on the group-based policy to enforce the group-based policy. In an example, regulating the network traffic includes, responsive to the network traffic exhibiting one or multiple network traffic parameters, and the network traffic being associated with a predetermined source role and the network traffic being associated with a predetermined destination role, applying a treatment indicated by the group-based policy. In an example, the group-based policy is a security policy, and regulating the network traffic includes selectively dropping packets of the network traffic. In an example, the group-based policy is a QoS policy, and regulating the network traffic includes selectively applying a QoS treatment to the network traffic. In an example, the group-based policy is a routing policy, and regulating the network traffic includes determining an IP forwarding address.

The instructions 704, when executed by the hardware processor, further cause the hardware processor to selectively uninstall the group-based policy based on a network activity associated with the application operating environment. In an example, selectively uninstalling the group-based policy based on the network activity includes determining whether a MAC table entry or an ARP table entry has expired. In an example, selectively uninstalling the group-based policy based on the network activity includes determining whether other application operating environments use the group-based policy. In an example, selectively uninstalling the group-based policy includes removing one or multiple entries from a TCAM of the network device.

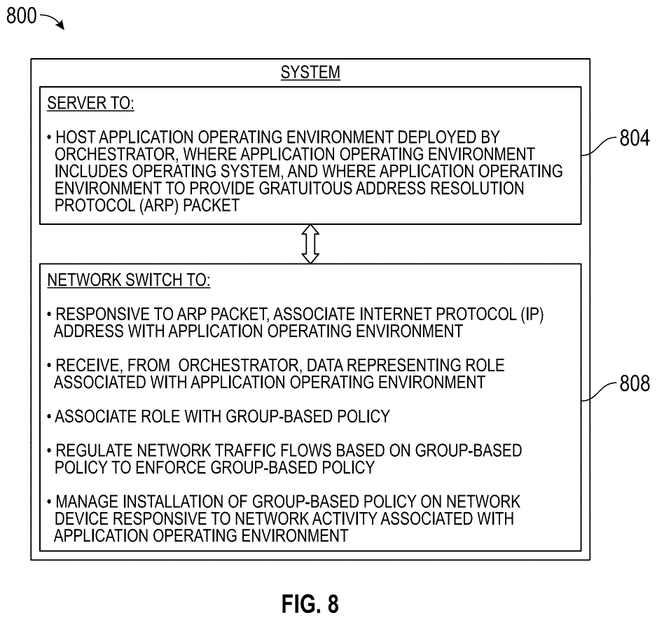

Referring to FIG. 8, in accordance with example implementations, a system 800 includes a server 804 and a network switch 808. In an example, the system 800 is associated with a data center. In an example, the server 804 and the network switch 808 are part of a rack. In an example, the network switch 808 is a ToR switch. In an example, the network switch 808 is an EVPN switch. In examples, the server 804 may be an enclosure-based server or a rack mount server. In an example, the system 800 is affiliated with a cloud (e.g., a public cloud, a private cloud or a hybrid cloud).

The server 804 hosts an application operating environment that is deployed by an orchestrator. The application operating environment includes an operating system, and the application operating environment provides a gratuitous address resolution protocol (ARP) packet. In an example, the application operating environment is a virtual machine, and the operating system is a guest operating system. In another example, the application operating environment is a bare-metal server, and the operating system is a host operating system. In an example, the orchestrator is associated with a cloud operator. In an example, the operating system is configured to provide a predetermined number of gratuitous ARP packets responsive to the starting, or launching, of the application operating environment.

The network switch, responsive to the ARP packet, associates an IP address with the application operating environment. In an example, the network switch extracts the IP address from the gratuitous ARP packet. In another example, the network switch extracts the IP address using a reverse ARP lookup based on a MAC packet.

The network switch 808 receives data provided by the orchestrator and representing a role associated with the application operating environment. In an example, the data represents a mapping structure associating IP addresses of application operating environments with roles. In an example, the data represents a TRIE structure including a tree of leaf nodes, where each leaf node is associated with a value that represents a role. In an example, each leaf node corresponds to an IP prefix. In an example, the network switch searches for a role associated with the IP address of the application operating environment using a longest prefix match. In an example, the IP address of the application operating environment corresponds to a sub-net indicated by the TRIE structure. In another example, the IP address of the application operating environment corresponds to an IP address of the TRIE structure. In an example, the role corresponds to a destination role.

The network switch 808 associates the role with a group-based policy. In an example, the group-based policy is a security policy. In another example, the group-based policy is a QoS policy. In another example, the group-based policy is a routing policy. In an example, the group-based policy is associated with a source role and a destination role. In an example, the group-based policy is associated with one or multiple network traffic parameters. In an example, the group-based policy is associated with one or multiple L3 parameters. In an example, the group-based policy is associated with one or multiple L4 parameters.

The network switch 808 regulates network traffic flows based on the group-based policy to enforce the group-based policy. In an example, the network switch permits or denies network traffic based on the group-based policy. In an example, the network switch applies a QoS treatment to network traffic based on the group-based policy. In an example, the network device routes network traffic based on the group-based policy.

The network switch 808 manages installation of the group-based policy on the network device responsive to a network activity that is associated with the application operating environment. In an example, the network switch 808 removes the group-based policy responsive to determining that neither the application operating environment nor any other application operating environment is associated with the role. In an example, the network device determines that the application operating environment is inactive responsive to the expiration of a MAC table entry. In an example, the network device determines that the application operating environment is inactive in response to the expiration of an ARP table entry.

In accordance with example implementations, detecting the presence of the application operating environment includes receiving, by the network device, a gratuitous ARP packet. The gratuitous ARP packet includes data associating the application operating environment with the IP address. Among the potential advantages, the network device determines the roles of application operating environments that do not undergo port access authentication.

In accordance with example implementations, detecting the presence of the application operating environment includes detecting, by the network device, entry of a MAC address corresponding to the application operating environment and an address mapping table of the network device. Among the potential advantages, the network device determines the roles of application operating environments that do not undergo port access authentication.

In accordance with example implementations, the address mapping table includes a MAC address table. Determining the IP address includes performing a reverse ARP look up of the IP address. Among the potential advantages, the network device determines the roles of application operating environments that do not undergo port access authentication.

In accordance with example implementations, detecting the presence of the application operating environment includes detecting, by the network device, entry of the IP address in an ARP table of the network device. Among the potential advantages, the network device determines the roles of application operating environments that do not undergo port access authentication.

In accordance with example implementations, managing installation of the group-based policy includes determining whether the group-based policy is installed on the network device, and responsive to determining that the group-based policy is not installed on the network device, installing the group-based policy on the network device. Among the potential advantages, the network device determines the roles of application operating environments that do not undergo port access authentication.

In accordance with example implementations, installing the group-based policy on the network device includes configuring, by the network device, a content addressable memory of the network device with an access control list corresponding to the group-based policy. Regulating the network traffic includes accessing, by a network device, the content addressable memory to apply the access control list based on the role and characteristics of the network traffic. Among the potential advantages, the network device determines the roles of application operating environments that do not undergo port access authentication.

In accordance with example implementations, the application operating environment includes a bare-metal server or a virtual machine. Among the potential advantages, the network device determines the roles of application operating environments that do not undergo port access authentication.

In accordance with example implementations, the application operating environment includes a virtual machine. Managing the installation of the group-based policy includes installing, by the network device, the group-based policy on the network device; and monitoring an activity of the virtual machine; and based on the activity, determining to uninstall the group-based policy. The group-based policy is uninstalled responsive to the determination to uninstall the group-based policy. Among the potential advantages, the network device determines the roles of application operating environments that do not undergo port access authentication.

In accordance with example implementations, the virtual machine is migrated. The monitoring of the activity of the virtual machine detects a network inactivity due to the migration. Determining to uninstall the group-based policy includes determining to uninstall the given group-based policy responsive to the detected network inactivity. Among the potential advantages, the network device determines the roles of application operating environments that do not undergo port access authentication.

In accordance with example implementations, monitoring the activity of the virtual machine includes monitoring an entry of an address mapping table associated with the IP address for a timeout. Determining to uninstall the group-based policy includes responding to the timeout. Among the potential advantages, the network device determines the roles of application operating environments that do not undergo port access authentication.

In accordance with example implementations, determining the role includes performing, by the network device, a longest prefix match on a TRIE data structure to identify a leaf node of the TRIE data structure. The TRIE structure includes data representing a mapping of IP address prefixes to a plurality of roles. The plurality of roles includes the role determined by the network device. The leaf node corresponds to data identifying the role determined by the network device. Among the potential advantages, the network device determines the roles of application operating environments that do not undergo port access authentication.

In accordance with example implementations, the TRIE data structure maps the role determined by the network device to another IP prefix of the IP address prefixes. Among the potential advantages, the network device determines the roles of application operating environments that do not undergo port access authentication.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
dynamically, on a network device, installing and uninstalling group-based policies based on an application operating environment activity associated with the network device, wherein dynamically installing and uninstalling the group-based policies comprises:
detecting, by a group-based policy management engine of the network device, presence of an application operating environment on a network associated with the network device; and
responsive to the detecting the presence of the application operating environment:
determining, by the group-based policy management engine, an Internet Protocol (IP) address of the application operating environment;
determining, by the group-based policy management engine, a role associated with the application operating environment based on the IP address;
identifying, by the group-based policy management engine, a given group-based policy corresponding to the role; and
installing, by the group-based network device, the given group-based policy on the network device; and
regulating, by the network device, network traffic flows received by the network device to enforce the given group-based policy.

2. The method of claim 1, wherein detecting the presence of the application operating environment comprises receiving, by the network device, a gratuitous Address Resolution Protocol (ARP) packet, wherein the gratuitous ARP packet comprises data associating the application operating environment with the IP address.

3. The method of claim 1, wherein detecting the presence of the application operating environment comprises detecting, by the network device, entry of a media access control (MAC) address corresponding to the application operating environment in an address mapping table of the network device.

4. The method of claim 3, wherein:
the address mapping table comprises a MAC address table; and
determining the IP address comprises performing a reverse address resolution protocol (ARP) look up of the IP address.

5. The method of claim 1, wherein detecting the presence of the application operating environment comprises detecting, by the network device, entry of the IP address in an Address Resolution Protocol (ARP) table of the network device.

6. The method of claim 1, wherein dynamically installing and uninstalling the group-based policies further comprises:
based on the application operating environment activity, determining that a second group-based policy of the group-based policies installed on the network device is not being used; and
responsive to the determination that the second group-based policy is not being used, removing the second group-based policy from the network device.

7. The method of claim 1, wherein:
installing the given group-based policy on the network device comprises configuring, by the network device, a content addressable memory of the network device with an access control list corresponding to the given group-based policy; and
regulating the network traffic comprises accessing, by the network device, the content addressable memory to apply the access control list based on the role and characteristics of the network traffic.

8. The method of claim 1, wherein the application operating environment comprises a bare-metal server or a virtual machine.

9. The method of claim 1, wherein:
the application operating environment comprises a virtual machine; and
dynamically installing and uninstalling the group-based policies further comprises:
monitoring an activity of the virtual machine;
based on monitoring the activity, determining to remove the given group-based policy; and
responsive to the determination to remove the group-based policy, uninstalling the given group-based policy.

10. The method of claim 9, wherein:
the virtual machine is migrated;
monitoring the activity of the virtual machine detects a network inactivity due to the migration; and
determining to remove the given group-based policy comprises determining to uninstall the given group-based policy responsive to the detected network inactivity.

11. The method of claim 9, wherein:
monitoring the activity of the virtual machine comprises monitoring an entry of an address mapping table associated with the IP address for a timeout; and
determining to uninstall the given group-based policy comprises responding to the timeout.

12. The method of claim 1, wherein:
determining the role comprises performing, by the network device, a longest prefix match on a TRIE data structure to identify a leaf node of the TRIE data structure;
the TRIE data structure comprises data representing a mapping of IP address prefixes to a plurality of roles;
the plurality of roles includes the role identified by the network device; and
the leaf node corresponds to data identifying the role determined by the network device.

13. The method of claim 12, wherein the TRIE data structure maps the role determined by the network device to another IP address prefix of the IP address prefixes.

14. A non-transitory storage medium that stores hardware processor-readable instructions that, when executed by a hardware processor of a network device, cause the network device to:
detect presence of an application operating environment on a network associated with the network device;
responsive to the detecting the presence of the application operating environment:
determine an Internet Protocol (IP) address of the application operating environment;
determine a role associated with the application operating environment based on the IP address;
identify a group-based policy corresponding to the role; and
install the group-based policy on the network device, wherein the network device regulates a network traffic based on the group-based policy to enforce the group-based policy; and
selectively uninstall the group-based policy based on a network activity associated with the application operating environment.

15. The storage medium of claim 14, wherein the instructions, when executed by the hardware processor, further cause the hardware processor to:
detect a timeout of an address mapping table entry associated with the IP address;
responsive to detecting the timeout:
determine whether the role is used by least one other application operating environment associated with the network device; and
responsive to determining that the role is not being used by the at least one other application operating environment, uninstall the group-based policy.

16. The storage medium of claim 14, wherein the instructions, when executed by the hardware processor, further cause the hardware processor to:
receive a gratuitous Address Resolution Protocol (ARP) packet, wherein the gratuitous ARP packet comprises data associating the application operating environment with the IP address; and
detect the application operating environment responsive to receiving the gratuitous ARP packet.

17. The storage medium of claim 14, wherein the instructions, when executed by the hardware processor, further cause the hardware processor to:
detect entry of an address corresponding to the application operating environment in an address mapping table of the network device; and
determine the IP address responsive to detecting the entry of the address in the address mapping table.

18. A system comprising:
a server to host an application operating environment deployed by an orchestrator, wherein the application operating environment comprises an operating system, and wherein the application operating environment to provide a gratuitous address resolution protocol (ARP) packet; and
a network switch to:
responsive to the ARP packet, associate an Internet Protocol (IP) address with the application operating environment;
receive data generated by the orchestrator and representing a role associated with the application operating environment;
associate the role with a group-based policy;
regulate network traffic flows based on the group-based policy to enforce the group-based policy; and
manage installation of the group-based policy on the network device responsive to a network activity associated with the application operating environment.

19. The system of claim 18, wherein:
the server is installed in a rack;
the application operating environment comprises a virtual machine; and
the switch comprises a top-of-the-rack (ToR) switch.

20. The system of claim 18, wherein:
the application operating environment comprises a first virtual machine; and
the network switch to further, responsive to a timeout of an address mapping table entry associated with the IP address:
determine whether the role is used by least one other virtual machine associated with the network switch; and
responsive to determining that the role not being used by the at least one other virtual machine, remove the group-based policy from the network device.
